(19) United States
(12) Patent Application Publication
(10) Pub. No.: US 2017/0287156 A1
(43) Pub. Date: Oct. 5, 2017

(54) MEASUREMENT APPARATUS, MEASUREMENT METHOD, AND ARTICLE MANUFACTURING METHOD

(71) Applicant: CANON KABUSHIKI KAISHA, Tokyo (JP)

(72) Inventor: Yuya Nishikawa, Utsunomiya-shi (JP)

(21) Appl. No.: 15/469,938

(22) Filed: Mar. 27, 2017

(30) Foreign Application Priority Data
Mar. 30, 2016 (JP) 2016-067156

(51) Int. Cl. G06T 7/60; G06T 7/00; G06T 7/73

(52) U.S. Cl. CPC G06T 7/60; G06T 7/73; G06T 7/0004

(57) ABSTRACT

A measurement apparatus for performing measurement of a position and posture of an object based on an image obtained by imaging the object, the apparatus comprising: a processor configured to perform specifying of a surface on which the object is placed based on the image and obtain the position and posture based on the specified surface.

### BACKGROUND OF THE INVENTION

### Field of the Invention

The present invention relates to a measurement apparatus, a measurement method, and an article manufacturing method.

### Description of the Related Art

In recent years, complicated tasks, for example, assembling an industrial product, are in the process of coming to be performed by robots, and in order to perform the tasks by robots, the measurement (recognition) of the position and posture of an object to be operated is needed. As a technique that measures the position and posture of the object, there is a method that uses both of a grayscale image and a distance image that have been obtained by imaging by a camera. In order to obtain the distance image, for example, a means that projects a pattern is needed and thereby the cost of an apparatus increases. Although it is desirable to use a method that uses only the grayscale image for recognizing the position and posture with an inexpensive device configuration, measurement errors easily occur since the distance image is not used. In order to reduce the measurement errors, Japanese Patent No. 4940715 discloses a method that registers stable postures of objects on a flat surface in advance, selects a stable posture that most matches (is consistent with) grayscale image data from among the registered stable postures, and obtains a more accurate position and posture in which the stable posture serves as an initial posture.

However, the method disclosed in Japanese Patent No. 4940715 assumes a case in which the objects are placed on a flat surface in a state in which the objects are not overlapped with each other, and does not assume a case in which the objects are overlapped with each other.

### SUMMARY OF THE INVENTION

The present invention provides, for example, a measurement apparatus advantageous in measurement of an object that is overlapped with another.

A measurement apparatus for performing measurement of a position and posture of an object based on an image obtained by imaging the object, that is one aspect of the present invention, comprises a processor configured to perform specifying of a surface on which the object is placed based on the image and obtain the position and posture based on the specified surface.

Further features of the present invention will become apparent from the following description of exemplary embodiments with reference to the attached drawings.

### BRIEF DESCRIPTION OF THE DRAWINGS

FIG. 1 illustrates an example of a configuration of a measurement apparatus.

FIG. 2 illustrates an arrangement state of objects.

FIG. 3 illustrates a flow of a measurement process of position and posture.

FIG. 4 illustrates divided regions of a captured image.

FIG. 5 illustrates a correspondence relation between pixels of the captured image and a placement surface

FIG. 6A illustrates a three-dimensional model of the object.

FIG. 6B illustrates postures that can be taken by the object with respect to the placement surface.

FIG. 7 illustrates a setting method of a placement region.

FIG. 8 illustrates the maximum distance between two points on an outline.

FIG. 9 illustrates the objects in an overlapping state.

FIG. 10 illustrates an example of height restriction.

### DESCRIPTION OF THE EMBODIMENTS

### First Embodiment

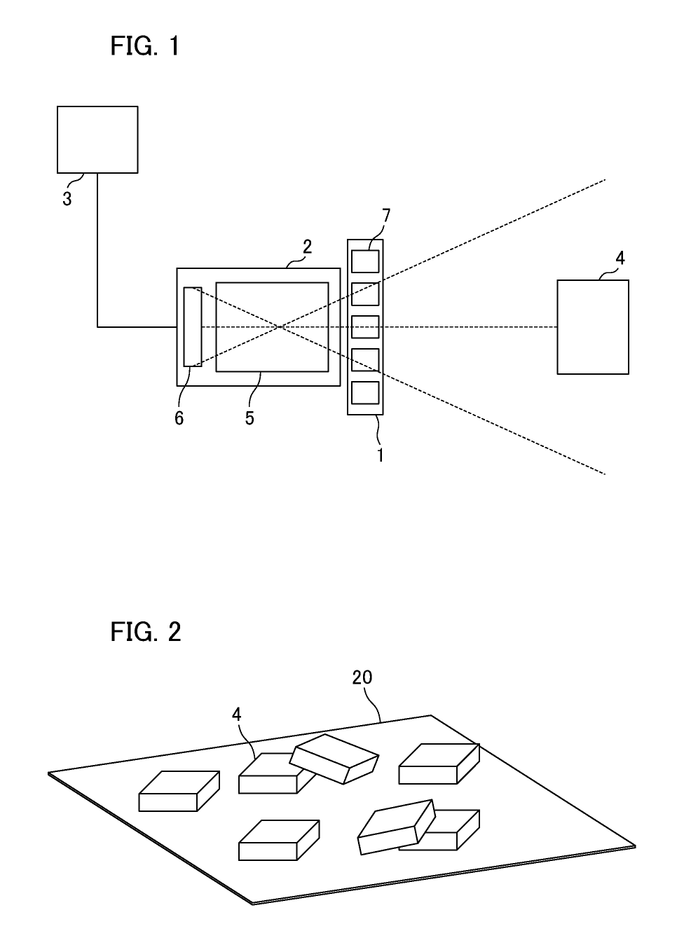

FIG. 1 is an overall view of a position and posture measurement apparatus in a first embodiment of the present invention. The position and posture measurement apparatus in the present embodiment is an apparatus that measures the position and posture of an object (object to be measured) by using a grayscale image. The position and posture measurement apparatus has an illumination device 1, an imaging device 2, and a processor 3. The illumination device 1 is an illumination device for uniformly illuminating an object 4, wherein, for example, a ring illumination, in which many LED light sources 7 are arranged in a ring around the optical axis of the imaging device 2, is used. Note that the illumination device 1 is not limited to the ring illumination, and any illumination that can substantially-uniformly illuminate the object 4, such as bar illumination and coaxial epi-illumination, may be used.

The imaging device 2 includes an imaging optical system 5 and an image sensor 6. The imaging optical system 5 is an optical system for forming an image of the object 4 that has been uniformly illuminated by the illumination device 1 onto the image sensor 6. Additionally, the image sensor 6 is an element for capturing image of the object 4, and, for example, a CMOS sensor and a CCD sensor can be used. The processor 3 calculates the position and posture of the object 4. First, edge information that corresponds to the ridge line and the outline of the object(s) 4 is extracted by using an edge detection algorithm such as the Canny method, with respect to the grayscale image that has been obtained by the imaging device 2, and then an edge detection image is calculated. Subsequently, the position and posture of each object are separately calculated to serve the above edge detection image as an input image.

FIG. 2 illustrates an example of an arrangement state of the object 4, which is a target to be measured. In the present embodiment, a plurality of objects 4 is placed on a placement surface 20. The objects 4 are placed on the placement surface 20 in a state in which the objects that are in an isolated state and the objects that are in an overlapping state are mixed. The shape of the placement surface 20 is not limited to a flat surface, for example, any shape including a curved surface shape and a step shape may be used.

In the present embodiment, the occurrence of an erroneous detection of the position and posture is suppressed to the maximum in the condition of both cases in which the three-dimensional coordinates of the placement surface of the object is known and the three-dimensional coordinates of the placement surface of the object is unknown (cases in which the placement surface can be specified and in which it cannot be specified) are mixed. Accordingly, in a typical position and posture estimation, the switching of estimated posture candidates at the time of model fitting is not performed for each object, whereas, in the present embodiment, the estimated posture candidates are switched for each object depending on cases in which the three-dimensional coordinates of the placement surface are known or unknown. If the three-dimensional coordinates of the placement surface are known, the posture that can be stably taken by the object 4 with respect to the placement surface 20 for which the three-dimensional coordinates are known is limited due to gravity. Consequently, it is possible to enhance estimation accuracy by limiting the freedom of the estimated posture candidates based on the shape of a component and shape information about the placement surface. If the three-dimensional coordinates of the placement surface are unknown, model fitting to serve any posture as an estimated candidate is performed, and accordingly, the postures not included in the posture limit condition can also be recognized correctly. The occurrence of an erroneous detection can be suppressed by selecting an optimum model fitting method depending on cases in which the three-dimensional coordinates of the placement surface are known or unknown as described above.

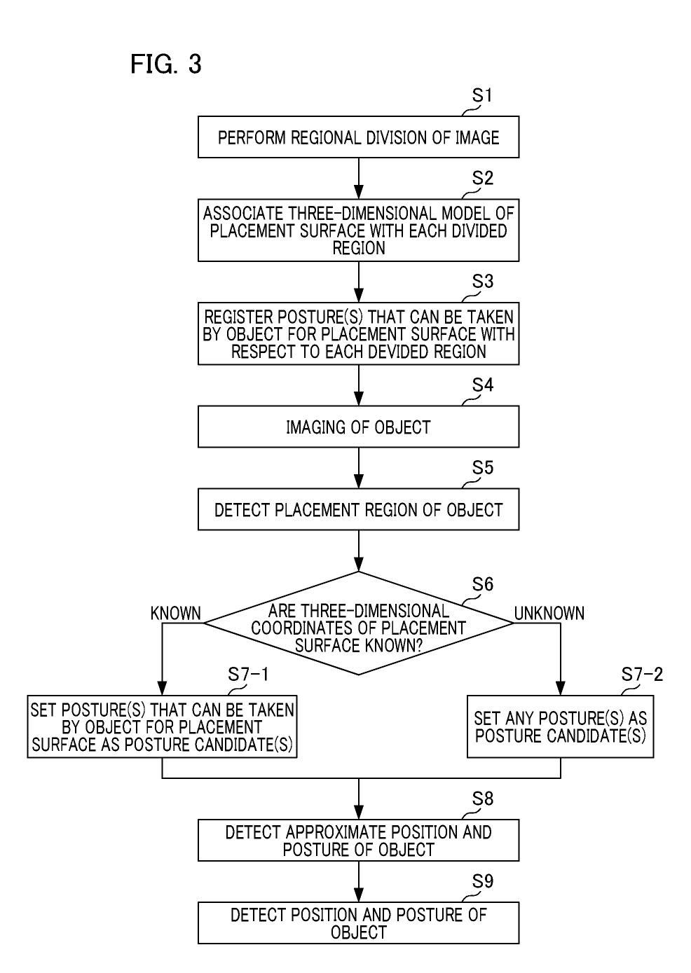

Next, with reference to FIG. 3, a description will be given of the measurement flow in a case in which the setting of the posture candidates is performed in advance. FIG. 3 illustrates the flow of a process that measures the position and posture of the object 4. In the present embodiment, a stable posture for each image region is set in advance by region dividing, so that the position and posture estimation of the component at run-time can be performed effectively. In FIG. 3, step S1 to step S3 are processes that need to be performed before the measurement in advance, step S4 to step S9 are run-time processes performed upon the measurement.

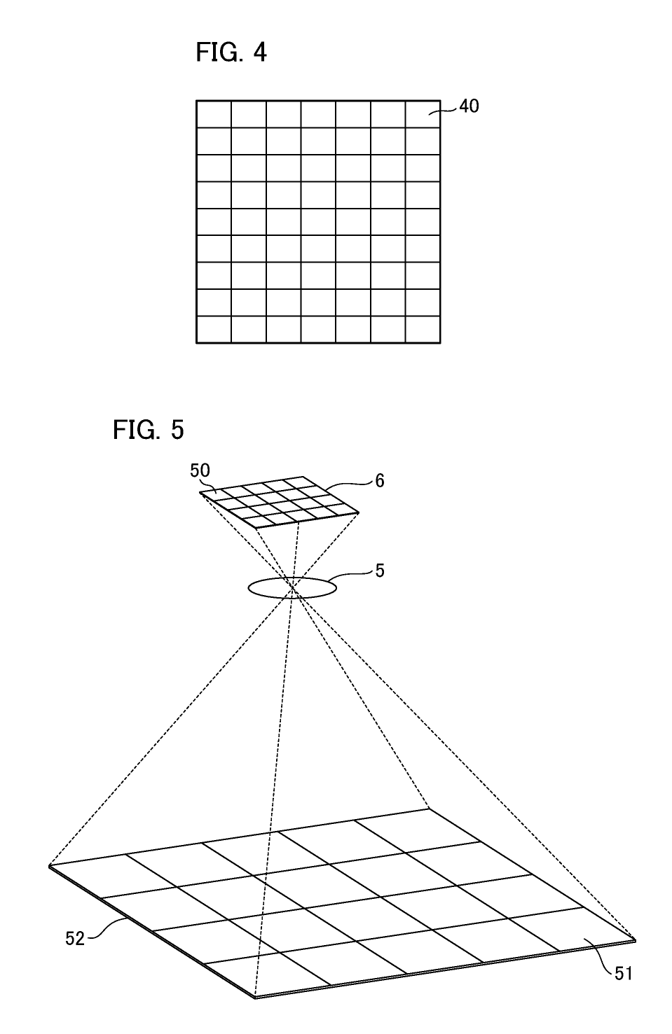

Step S1 is a process that performs the regional division of an image. If the placement surface is a flat surface, the posture candidates that can be taken with respect to the placement surface are fixed in any regions in the captured image. In contrast, if the placement surface is a curved surface or a step shape, the posture candidates that can be taken for each region in the placement surface are not fixed. If the posture candidates that can be taken are not fixed for each divided region in the placement surface, the posture candidates that can be taken by the object are registered in advance for each divided region, and consequently, the calculation can be performed effectively. In the process, as shown in FIG. 4, the region dividing of the image captured by the image sensor 6 is performed. FIG. 4 illustrates divided regions of the captured image. The size of divided regions 40 is determined depending on the size of the placement surface region that can be regarded as the same stable posture. It is impossible to consider that the stable posture changes within a range equal to or less than the size of the object because the placement surface is a supply region of the object. Thus, in the present embodiment, the size of the divided regions 40 is determined in accordance with that of the object 4, for example, if the object 4 is captured within a 10×10 pixel size on the image sensor 6, the size of the divided regions 40 is set to 10×10 pixels. Note that the size of the divided regions 40 is not limited to matching the size of the object, and the divided region may be any size.

Step S2 is a process that associates the three-dimensional model of the placement surface with each divided region calculated in step S1. In the process, first, based on the three-dimensional shape model of the placement surface that is known and the position and posture information of the placement surface on the camera coordinate space, the three-dimensional shape model of the placement surface arranged on the camera coordinate space is projected to an image plane of the image sensor 6. One example of a projection method for projecting to the image plane is a projection based on a pinhole camera model. The three-dimensional model of placement surface is projected to the image plane by using internal parameters (focus distance, principle point) and external parameters (position, posture) of the camera that have been obtained by calibration performed in advance. Subsequently, as shown in FIG. 5, the correspondence relation between each pixel of the image sensor 6 and a three-dimensional model 52 of the placement surface projected to the image plane as described above is determined. Regions of the placement surface corresponding to pixel addresses 50 on the image sensor 6 are correspondence regions 51. Subsequently, based on the above correspondence relation, the correspondence regions on the three-dimensional model of the placement surface on the camera coordinate space are each determined with respect to each divided region of the image sensor 6 that has been determined in step S1.

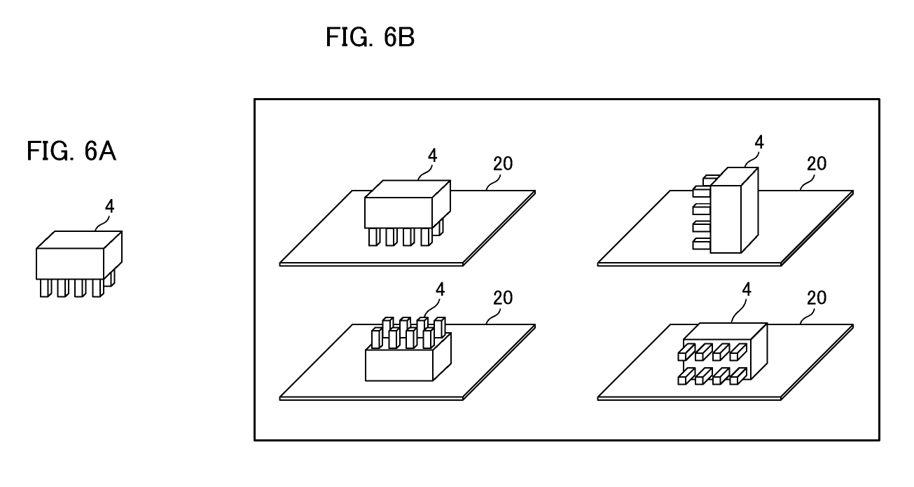

Step S3 is a process that previously registers the posture taken by the object for each divided region with respect to the placement surface. In the process, the posture which the three-dimensional model of the object 4 can take with respect to the three-dimensional model of the placement surface is registered for each divided region of the captured image that has been associated with the three-dimensional model of the placement surface in the above-described processes. For example, if the three-dimensional model of the object 4 is a shape shown in FIG. 6A, the postures that can be taken with respect to the three-dimensional model of the placement surface are, in total, four postures as shown in FIG. 6B. Step S4 is a process that images the object 4. The captured image is obtained by imaging of the object 4 that has been uniformly illuminated by the illumination device 1 by the imaging device 2.

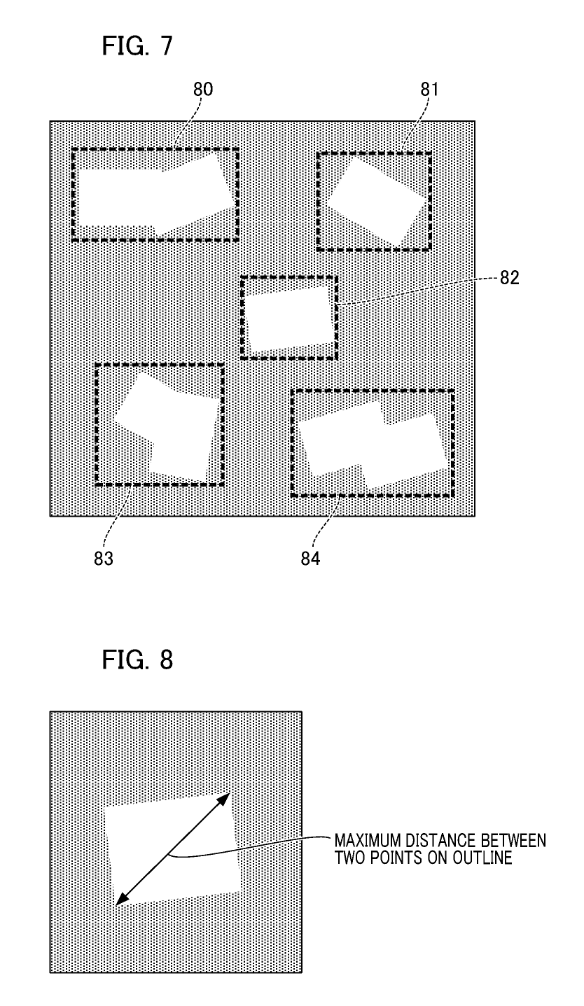

Step S5 is a process that detects a placement region of the object. In the process, the region where the object 4 exists is extracted based on the captured image obtained in step S4, and the placement region is set. The determination whether or not the object exists is performed by using, for example, a binary image obtained by binarizing the captured image, and if a connected region equal to or larger than the area corresponding to the size of the object exists, it is determined to be a region where the object exists. Subsequently, the placement region is set to surround the connected region. FIG. 7 illustrates the placement region. In FIG. 7, a case in which reflectance of the object 4 is higher with respect to the placement surface 20 is assumed, and, in the binarized image, the object 4 displayed in white is represented by white and the placement surface 20 displayed in black is represented by dots. The placement regions 80 to 84 are set to surround the connected region of the objects 4 displayed in white silhouettes.

Step S6 is a process that determines whether or not the three-dimensional coordinates of the placement surface of the object is known, in other words, whether or not the placement surface can be specified. The determination of whether or not the three-dimensional coordinates of the placement surface of the object in the process has already been performed is carried out by determining that the object is in an isolated state or an overlapping state. If one object is not overlapped with another object and thus is in an isolated state, the object is grounded only on the placement surface, so that the three-dimensional coordinates of the placement surface of the object are known (the placement surface can be specified). In contrast, if the objects are overlapped with each other, one object is placed on another object, so that the three-dimensional coordinates of the placement surface of the object are unknown (the placement surface cannot be specified).

In the process, in order to determine whether or not the objects are in an isolated state or in an overlapping state, for example, the area of the silhouette of the binary image calculated in step S5 is calculated. Subsequently, it is determined whether or not the calculated silhouette area is larger than the threshold. If the calculated silhouette area is larger than the threshold, it is determined that a plurality of objects is overlapped with each other, and if it is equal to or less than the threshold, it is determined that the object is a single component in an isolated state. The threshold may be, for example, the maximum area of the object 4 assumed from a preset three-dimensional model of the object 4, or may be a value optionally set. For example, in FIG. 7, if the area of the white silhouette calculated from the captured image is larger than the assumed maximum area, it is determined that a plurality of objects is overlapped with each other, and if the area is smaller, it is determined that the object is a single component in an isolated state. The determination of the existence or nonexistence of the above overlapping is performed with respect to all the placement regions determined in step S5.

Note that the criterion for determining the existence or nonexistence of the overlapping in the present embodiment is not limited to the area of the silhouette, and any criterion may be used, for example, the maximum distance between two points on the outline (the maximum value of the distance) as long as the determination is enabled as to the existence or nonexistence of the overlapping. As shown in FIG. 8, the maximum distance between two points on the outline (the maximum value of the distance) is obtained by extracting the outline of the silhouette and calculating the distances between two points on the extracted outline. If the maximum distance between the two points on the calculated outline is longer than the threshold, it is determined that a plurality of objects is overlapped with each other, and if the maximum distance is equal to or less than the threshold, it is determined that the object is a single component in an isolated state. This threshold may be, for example, the maximum distance between two points on the outline of the object 4 assumed from a preset three-dimensional model of the object 4, or may be any length set in advance.

In step S6, if the three-dimensional coordinates of the placement surface of the object are determined to be known, the process proceeds to step S7-1, and if the three-dimensional coordinates of the placement surface of the object are determined to be unknown, the process proceeds to step S7-2. Step S7-1 is a process in which the posture that can be taken by the object with respect to the placement surface is set as an estimated posture candidate. If the three-dimensional coordinates of the placement surface of the object are determined to be known, the object 4 has been determined to be grounded only on the placement surface, and thus, the posture that can be taken by the object 4 is any one of the postures registered in step S3. Accordingly, the posture that can be taken by the object with respect to the placement surface registered in step S3 is set as an estimated posture candidate. Subsequently, based on the correspondence relation between the divided regions set in step S1 and the placement region of the object, the estimated posture candidate is set for each object. If the placement region of the object crosses the plurality of divided regions set in step S1, for example, all of the registered postures may be served as the estimated posture candidates in the plurality of divided regions. Note that, in the present embodiment, the setting of the estimated posture candidate in a case in which the placement region of the object crosses the plurality of divided regions is not limited to the above, and, for example, the posture registered with respect to some of the divided regions among the plurality of divided regions may be served as an estimated posture candidate.

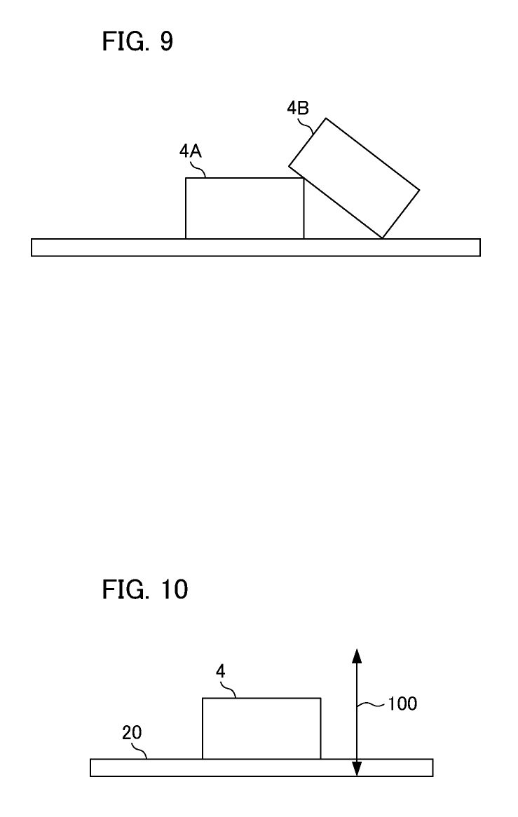

Additionally, in the present embodiment, although the estimated posture candidate is set in advance for each region, if the estimated posture candidate has not been set in advance, the stable posture to be served as the estimated posture candidate may be calculated based on the three-dimensional coordinates of the placement surface and the shape of the object in this process. As a case in which the posture candidate cannot be set in advance, for example, a case is assumed in which the objects are overlapped with each other and the position and posture of an object 4A placed below an object 4B as shown in FIG. 9 can be specified during measurement and the three-dimensional coordinates of the placement surface of the object 4B is known during measurement. Additionally, a case in which the object is placed on a belt conveyor and the three-dimensional coordinates of the placement surface dynamically change is assumed.

Step S7-2 is a process that sets any posture as an estimated posture candidate. If the three-dimensional coordinates of the placement surface of the object is determined to be unknown, the object is in a posture different from the posture registered in step S3 since the object is placed so as to overlap another object, so that it is impossible to predict the three-dimensional coordinates of the placement surface in the placement region of the object. Accordingly, if the three-dimensional coordinates of the placement surface of the object are determined to be unknown, any posture is set as an estimated posture candidate. Note that the set resolution of the posture is set in accordance with target posture accuracy.

Finally, in step S8 and step S9, the position and posture of the object 4 is calculated. The calculation of the position and posture is performed by, for example, two processes, that is, a process that estimates the schematic position and posture and a process that estimates the position and posture with higher accuracy, which serves the schematic position and posture as an initial value. Step S8 is a process that detects the approximate position and posture of the object. In this process, the schematic position and posture of the object is detected by, for example, a method using an algorithm of the ensemble classification tree. In the method using algorithm of the ensemble classification tree, first, many learning patterns are generated by using images of the object that have been captured from various directions in advance, and the ensemble classification tree is generated based on the learning patterns. Subsequently, by using the ensemble classification tree, voting is performed to many posture voting surfaces, and the schematic position and posture of each object is specified based on a voting score. Note that the method that detects the schematic position and posture of the object is not limited to the method using the algorithm of the ensemble classification tree. Additionally, step S8 may be performed before the determination whether or not the three-dimensional coordinates are known and may be performed between step S4 and step S9.

Step S9 is a process that detects the position and posture of the object. In this process, the position and posture are estimated with high accuracy by model-fitting the three-dimensional model of the known object to the captured result to serve the schematic position and posture of the calculated object as an initial value. Specifically, the model fitting is performed to serve the schematic position and posture calculated in step S8 as an initial value and to serve any one of the posture candidates set in step S7-1 and step S7-2 as an estimated position candidate. The model fitting is performed, for example, by using the difference between geometric features (edges) corresponding to the outline and the ridge line set with respect to the three-dimensional model of the object and geometric features (edges) extracted from the captured image, and estimating the position and posture of the object so as to minimize the difference. Note that the model fitting described above is performed by switching the estimated posture candidates for each placement region set in step S5.

Note that if the three-dimensional coordinates of the placement surface of the object are known, it is possible to perform the position and posture estimation to which the limitation of the height 100 in the gravity direction is also added in addition to the above-described posture restriction as shown in FIG. 10. If the object 4 is in an isolated state, the object 4 should be grounded to the placement surface due to the gravity, so that, for example, the height 100 is limited to the maximum height of the object 4. The model fitting in the present embodiment is not limited to the posture restriction of the object, and it may add the above height restriction in addition to the posture restriction.

Additionally, in a case in which the postures that can be taken by the object are not fixed for each position of the placement surface, for example, a case in which the placement surface is spherical, the method for measuring the position and posture that assumes a case in which the placement surface is flat may cause erroneous measurement of the position and posture of the object even if the objects are not overlapped with each other. In this case, through step S1 to step S5, step S7-1, step S8, and step S9, the region on the image and the three-dimensional coordinates of the placement surface are associated with each other, and the estimated posture candidate of the object is limited for each divided region, and consequently, erroneous measurement can be suppressed. In this case, the determination of step S6 is not performed.

As described above, according to the present embodiment, even in a state in which the objects are overlapped with each other, if only the grayscale image is used for the measurement of the position and posture, it is possible to provide a measurement apparatus that suppresses erroneous measurement of the position and posture of the object. Note that although the present embodiment is a technique that is particularly effective for a position and posture measurement apparatus using the grayscale image, the present invention is not limited to this, and may be applied to a position and posture measurement apparatus using a distance image and a position and posture measurement apparatus using both of the grayscale image and the distance image.

### Embodiment According to an Article Manufacturing Method

The measurement apparatus according to the embodiments described above is used in an article manufacturing method. The article manufacturing method includes a process of measuring a position of an object using the measurement apparatus, and a process of processing the object on which measuring is performed in the process or the object in the process. The processing includes, for example, at least one of machining, cutting, transporting, assembly, inspection, and sorting. The article manufacturing method of the embodiment is advantageous in at least one of performance, quality, productivity, and production costs of articles, compared to a conventional method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-067156, filed Mar. 30, 2016, which is hereby incorporated by reference wherein in its entirety.

What is claimed is:

1. A measurement apparatus for performing measurement of a position and posture of an object based on an image obtained by imaging the object, the apparatus comprising:
a processor configured to perform specifying of a surface on which the object is placed based on the image and obtain the position and posture based on the specified surface.

2. The measurement apparatus according to claim 1, wherein the processor is configured to perform determination of whether the object and another object are overlapped with each other, and perform the specifying based on the determination.

3. The measurement apparatus according to claim 2,
wherein the processor is configured to perform the specifying in a case where the determination, that the object and the other object are not overlapped with each other, is performed.

4. The measurement apparatus according to claim 2,
wherein the processor is configured to perform extraction of a region corresponding to the object from the image and perform the determination based on an area of the region.

5. The measurement apparatus according to claim 2,
wherein the processor is configured to perform extraction of a region corresponding to the object from the image and perform the determination based on a maximum value of a distance between two points on an outline of the region.

6. The measurement apparatus according to claim 4,
wherein the processor is configured to perform the extraction by binarization of the image.

7. The measurement apparatus according to claim 2,
wherein the processor is configured to perform the specifying in a case where a position and posture of the other object is known even in a case where the determination, that the object and the other object are overlapped with each other, is performed.

8. The measurement apparatus according to claim 1,
wherein, in a case where the processor performed the specifying, the processor is configured to obtain the position and posture from a candidate as a position and posture that can be taken by the object relative to the surface obtained by the specifying.

9. The measurement apparatus according to claim 8,
wherein the processor is configured to obtain the position and posture that can be taken by the object that is associated in advance with each of a plurality of regions obtained by dividing the image.

10. A measurement method of performing measurement of a position and posture of an object based on an image obtained by imaging the object, the method comprising steps of:
performing specifying of a surface on which the object is placed based on the image; and
obtaining the position and posture based on the specified surface.

11. A method of manufacturing an article, the method comprising steps of:
performing measurement of a position and posture of an object using a measurement apparatus; and
performing processing of the object, of which the measurement has been performed, to manufacture the article,
wherein the apparatus includes a processor configured to perform specifying of a surface on which the object is placed based on the image and obtain the position and posture based on the specified surface.
